(19) United States
(12) Patent Application Publication
(10) Pub. No.: US 2002/0181676 A1
(43) Pub. Date: Dec. 5, 2002

(54) System for connecting first and second items of computer equipment through a telecommunication network

(76) Inventors: Thierry Noblot, Amneville (FR); Daniel Aime, Besancon (FR); Marcel Gachenot, Vantoux (FR); Katherine Tourne, Augny (FR)

Correspondence Address: YOUNG & THOMPSON, 745 SOUTH 23RD STREET 2ND FLOOR, ARLINGTON, VA, 22202

(21) Appl. No.: 10/147,899

(22) Filed: May 20, 2002

(30) Foreign Application Priority Data
May 21, 2001 (FR) 0106671

(51) Int. Cl. H04M 11/00; H04M 1/56; H04M 15/06

(52) U.S. Cl. 379/93.02; 379/142.05

(57) ABSTRACT

System for connecting first and second items of computer equipment through a telecommunication network This system for connecting first and second items of computer equipment (1, 2) through a telecommunication network (3), a telephone number being assigned to each of these items of equipment, is characterized in that it comprises call means (1) for calling the second item of equipment, to which means a telephone number is assigned, and in that the second item of equipment (2) comprises means (6, 7) of retrieval of the telephone number assigned to the call means without taking the line off-hook, means (6, 8) of identification of the call means and of retrieval from a database (8) of a telephone number assigned to the first item of equipment (1) and call means (6, 7) for calling the latter item of equipment via this number through the telecommunication network (3), so as to allow connection.

The present invention relates to a system for connecting first and second items of computer equipment through a telecommunication network.

These items of equipment are formed for example by microcomputers or servers for remote access to information systems which are for example equipped with modems with which telephone numbers are associated.

These modems may for example be secure modems which incorporate a combination formed for example of a parametrizable key which must be identical for the two modems incorporated into the two items of equipment so as to allow their connection.

However, these secure modems have a number of drawbacks especially as regards their cost, owing to the fact that there is no secure modem for portable microcomputers of PCMCIA type, nor for portable telephones, the difficulties relating to their implementation insofar as the modem must be parametrized for each calling item of equipment by indicating the callback number which will be unique with respect to the modem of the calling item of equipment and the possibilities of piracy by using a modem of identical type and a key generator.

The state of the art also includes services of automatic callback of software for remote handshaking of an item of computer equipment such as for example software of the “PC ANYWHERE” type.

This type of software is fairly secure but it only allows handshaking with regard to an item of computer equipment. In fact, it only allows a single connection at a time with regard to a server or any item of equipment located for example within an enterprise.

Another service is also well known in the state of the art, namely the RAS (“Remote Access Service”) service. Most of the operating systems of remote access servers incorporate this functionality.

This service allows a user possessing for example a microcomputer fitted with a modem, to dial up the call number of an RAS remote access server. This dialling can only be done from the microcomputer linked to a fixed or mobile telephone set.

The RAS server then receives the call and takes the line off-hook.

This already exhibits a first drawback insofar as the taking of the line off-hook causes payment for the communication by the user.

Next, the server and the microcomputer exchange identification information, such as for example registration information of the “LOGIN” type and a connection password for defining the privileges for access to the remainder of the information system as well as the telephone number for user callback.

This exchange must happen within a specified time or with a maximum number of attempts.

If this time elapses or if this maximum number of attempts is reached, the communication is cut by the server.

It is during this phase that piracy may be effected by usurpation of identity or trespassing into the server.

Specifically, such a system may be susceptible to piracy since there is connection between the server and the user and certain piracy software may enter and modify the properties of the RAS server and subsequently trespass into the information system proper.

In this case, there is indeed no certainty regarding the origin of the user who is calling the RAS server.

The system then remains open to the call of any user, since in all cases the RAS server takes the line off-hook and issues the user connection invitation.

Once the various items of identifying information have been declared valid, from a database for example and once the allocating of the access rights and of the callback telephone number which are defined in this base in respect of the user has been carried out, connection continues. The RAS server hangs up and the user's microcomputer stands by awaiting receipt of a call.

The RAS remote access server then calls back the user's microcomputer which receives the call and takes the line off-hook, hence making it possible to establish the connection between the user and the information system.

In view of the foregoing, it is noted that such a connection is not secure and that the information system is susceptible to piracy.

The aim of the invention is therefore to solve these problems.

To this end, the subject of the invention is a system for connecting first and second items of computer equipment through a telecommunication network, a telephone number being assigned to each of these items of equipment, characterized in that it comprises call means for calling the second item of equipment, to which means a telephone number is assigned, and in that the second item of equipment comprises means of retrieval of the telephone number assigned to the call means without taking the line off-hook, means of identification of the call means and of retrieval from a database of a telephone number assigned to the first item of equipment and call means for calling the latter item of equipment via this number through the telecommunication network, so as to allow connection.

The invention will be better understood on reading the description which follows, given merely by way of example and while referring to the appended drawings in which:

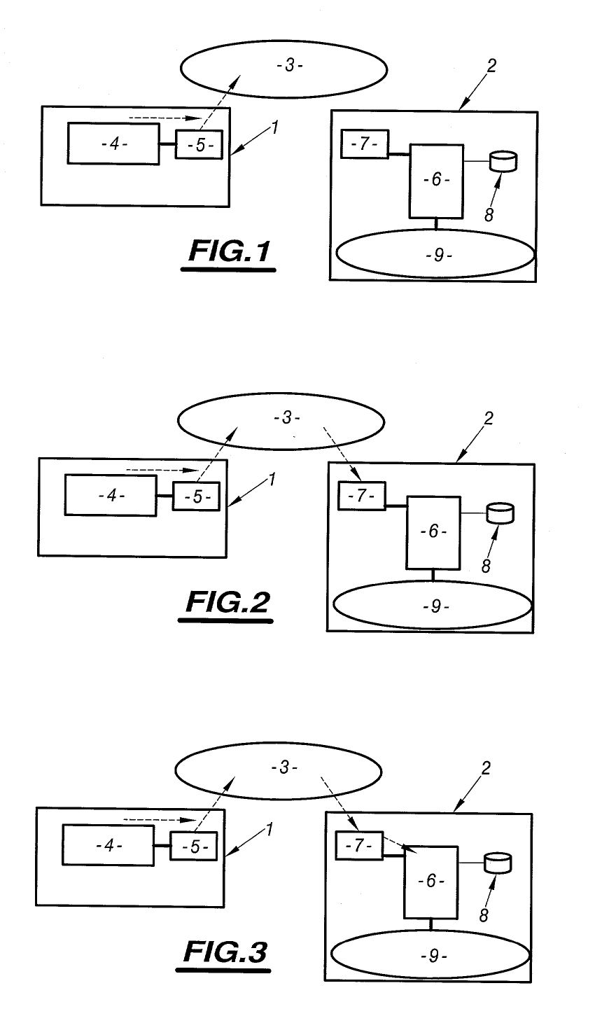

FIGS. 1 to 12 represent schematic diagrams of a connection system according to the invention, illustrating, on the one hand, the general structure thereof and, on the other hand, its manner of operation.

As was indicated earlier, the invention concerns a system for connecting the first and second items of computer equipment through a telecommunication network, a telephone number being assigned to each of these items of equipment.

The items of computer equipment may be of different types and kinds and in the example which will be described subsequently, the connection of a microcomputer and of an information system, for example of an enterprise, through a remote access server of RAS type has been illustrated.

Thus, for example, in these figures the general reference 1 designates the first item of equipment, the general reference 2 the second item of equipment and the general reference 3 the telecommunication network 3.

A telephone number is assigned to each of these items of equipment and is established by the operator of the telecommunication network.

As was indicated earlier, the first item of equipment can for example comprise a microcomputer designated by the general reference 4 associated with a modem designated by the general reference 5, attached to the telecommunication network.

The second item of equipment can for its part comprise an RAS authentication remote access server designated by the general reference 6 associated with a modem designated by the general reference 7 and with a database designated by the general reference 8, which will be described in greater detail subsequently.

The modem 7 is also linked to the telecommunication network.

This RAS access server makes it possible for example to obtain access to an enterprise's information system designated by the general reference 9 in these figures.

The aim of the system described is therefore to allow a microcomputer to access an information system, of an enterprise for example, a private network, an Internet access, etc. through a telephone operator and a telephone network, and to do so in a secure manner so as to facilitate teleactivity.

To do this, security should be implemented so as to be certain that an unknown user does not connect to the information system.

Any usurpation of identity of a user should therefore be prevented so as to prevent any trespass of the information system with a view to piracy.

This is achieved by implementing a processing of the telephone numbers of various parties, each telephone number being assigned by the operator of the telephone network and being unique and individual to each party attached to the network, whether at a fixed or mobile set. This number cannot in fact be falsified by the caller or at the very least not before the called item of equipment has taken the line off-hook, since it is the operator of the telephone network who manages these numbers and the network.

A description will be given below of an exemplary implementation of the system according to the invention, in which a user who wishes to obtain access to an information system such as the system 9, employs the microcomputer 4 associated with the modem 5.

During the step illustrated in FIG. 1, the user triggers the dialling to the authentication remote access server 6.

In the example described this dialling is done from the microcomputer 4.

Other examples will be described in order to demonstrate that the calling of the server 6 can also be effected by the user from means separate from this microcomputer, such as for example from a fixed or mobile telephone set associated with the telephone network

As is illustrated in FIG. 2, this call is then routed through the telecommunication network 3 to the server and more particularly the modem 7 of the latter.

The authentication server and more particularly the modem associated with the latter then receives this call, but does not take the line off-hook. This makes it possible, on the one hand, to avoid user payment for the communication and, on the other hand, to keep the telephone number of the calling item of equipment secret.

Specifically, if the server goes off-hook, as occurs in the state of the art, the telephone number of the calling item of equipment can be retrieved and be usurped by various systems easily accessible in the state of the art.

During the step illustrated in FIG. 3, the telephone number of the calling item of equipment is retrieved by the remote access server 6 through its modem 7, in a conventional manner and still without taking the line off-hook.

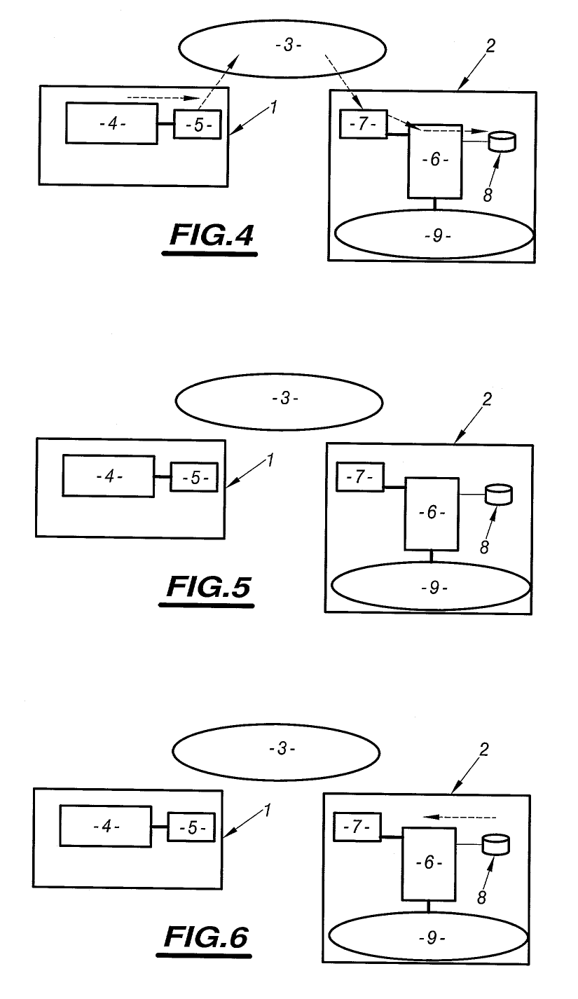

During the step illustrated in FIG. 4, the remote access server 6 identifies the call means by comparing the telephone number retrieved with information contained in the database 8, the latter storing information relating to a table of authorized users and to one or more preregistered telephone numbers which are associated therewith.

This makes it possible to verify the validity of the access of a calling user.

During the phase illustrated in FIG. 5, the call originating from the user is interrupted for example after a predetermined period of time or a predetermined number x of rings.

The first item of equipment, that is to say in fact the first microcomputer employed by the user, is then on standby awaiting receipt of a call.

During the step illustrated in FIG. 6, the user is declared valid by the remote access server 6 and a callback telephone number associated with this user is retrieved by the access server 6 from the database 8, from the corresponding table, so as to trigger callback of the first item of equipment.

It is thus appreciated that this callback is effected on the basis of a telephone number stored, in respect of an identified user, in the database associated with the server.

It will be noted that this procedure on the one hand makes it possible to call only identified items of equipment and validated users and on the other hand allows this user to use for example an item of telephone equipment which is different from the first item of computer equipment in order to call the server.

This other item of telephone equipment can then be assigned a different telephone number from the first item of computer equipment which has to be connected to the server.

The telephone number of the calling item of equipment is therefore retrieved by the RAS server only for access validation and user identification purposes and is not used as callback number for the first item of computer equipment.

Of course, these telephone numbers may be identical if the user has triggered the calling of the server from the microcomputer which the server must call back subsequently.

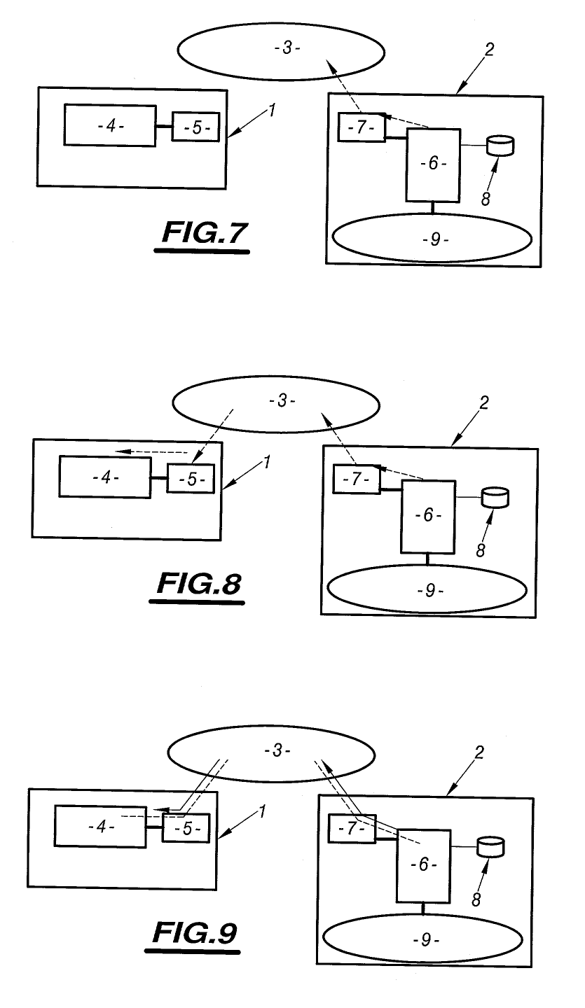

During the step illustrated in FIG. 7, the access server triggers the calling of the user through the telephone network by virtue of its modem.

During the step illustrated in FIG. 8, the first item of equipment receives the call originating from the server and-takes the line off-hook.

During the step illustrated in FIG. 9, means of exchanging information of conventional type between the items of equipment are activated so as to allow the server to ask the user for a certain amount of identification and authentication information, such as for example registration information of the “LOGIN” type and a connection password for defining the privileges of access to the information system.

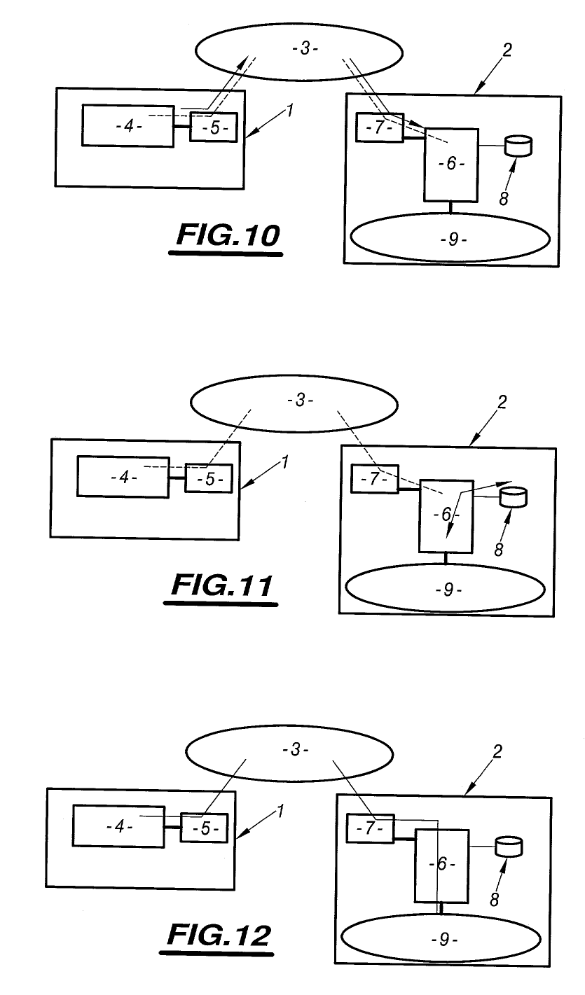

During the steps illustrated in FIGS. 10 and 11, the user enters this various information into the microcomputer and this information is transmitted through the telecommunication network towards the server.

It will be noted that this must for example be carried out in a predetermined period of time or with a maximum number of attempts before communication cutoff by the RAS server.

Once this information has been gathered at the level of the remote access server 6, the latter verifies this information by comparing it for example with corresponding information from the database 8 and by allocating access rights defined in this base in respect of this user.

As is illustrated in FIG. 12, this makes it possible to establish the connection between the first and the second items of equipment, that is to say between the microcomputer and the information system.

It goes without saying of course that yet other embodiments of this system may be envisaged.

Thus, as was indicated earlier, the calling of the server may be effected by the user by implementing a different item of telephone equipment from the first item of equipment to be connected.

This item of equipment may for example be a fixed telephone or a mobile telephone making it possible to activate the remote access server and to induce the latter, after verification, to use a callback telephone number stored in the database in order to call back the first item of computer equipment.

Such a structure exhibits a number of advantages especially as regards security of connection.

Specifically, it is firstly necessary to know the telephone number of the remote access server.

The telephone number retrieved, that is to say the one corresponding to the calling item of equipment, cannot be falsified before the line is taken off-hook, since it is allocated by the operator of the telephone network.

If the telephone number of the calling item of equipment is withheld, the remote access server cannot react, since this number is indispensable to it for accessing the database.

There cannot be any trespass for piracy of the base of the users of the remote access server, since this server does not take the line off-hook. There is therefore no linkup between the user and the server during this authentication phase.

This remote access server calls back a predefined number of the user and which is stored in the database.

It is then appreciated that even if a user has succeeded in usurping the identity of someone else, the server calls back only the number which is in the database and not the one which is presented to it during the call. This makes it possible to offer multiple possibilities of calling for authentication, for example from a portable telephone and callback of the server on a fixed telephone line associated with the first item of equipment.

An extra level of security is introduced with the authentication information, for example the password, so as to afford access to the remote information system according to the access privileges defined beforehand in the database of users.

The addition of a predetermined time limit in which to enter this identification information also avoids the possibility of multiple tests of various combinations by implementing for example appropriate piracy software.

This can also be achieved by limiting the number of information entry attempts.

Finally, the use of a virtual private network can also add further to security.

Specifically, the telephone operator can put in place a virtual private network with dialling on the basis of a different number of digits from that used in the public one.

1. System for connecting first and second items of computer equipment (1, 2) through a telecommunication network (3), a telephone number being assigned to each of these items of equipment, characterized in that it comprises call means (1) for calling the second item of equipment, to which means a telephone number is assigned, and in that the second item of equipment (2) comprises means (6, 7) of retrieval of the telephone number assigned to the call means without taking the line off-hook, means (6, 8) of identification of the call means and of retrieval from a database (8) of a telephone number assigned to the first item of equipment (1) and call means (6, 7) for calling the latter item of equipment via this number through the telecommunication network, so as to allow connection.

2. System according to claim 1, characterized in that the call means are formed by the first item of equipment (1).

3. System according to claim 1, characterized in that the call means are formed by an item of telephone equipment separate from the first item of equipment (1) and attached to the telephone network (3).

4. System according to any one of the preceding claims, characterized in that the first and second items of equipment (1, 2) comprise means (4, 5, 6, 7, 8) of exchange of information identifying the user of the first item of equipment (1).

5. System according to any one of the preceding claims, characterized in that the first item of equipment comprises a microcomputer (4) equipped with a modem (5) and the second item of equipment comprises a server (6) for remote access to an information system (9), also equipped with a modem.
